(19) United States
(12) Patent Application Publication
(10) Pub. No.: US 2021/0007332 A1
(43) Pub. Date: Jan. 14, 2021

(54) FEEDER WITH A FEED TROUGH

(71) Applicant: ARISTOS GEROGIANNIS, ASPROPYRGOS ATTIKIS (GR)

(72) Inventor: ARISTOS GEROGIANNIS, ASPROPYRGOS ATTIKIS (GR)

(21) Appl. No.: 16/982,752

(22) PCT Filed: Mar. 29, 2019
(86) PCT No.: PCT/GR2019/000024

§ 371 Date: Sep. 21, 2020

(30) Foreign Application Priority Data
Mar. 29, 2018 (GR) 20180100134

(51) Int. Cl. A01K 53/00

(52) U.S. Cl. CPC A01K 53/00

(57) ABSTRACT

The invention relates to a feeder with a small stimulating feed trough, consisting of a tray (2) for supplying liquid food and a frame (1) for providing food in solid form. Inside the frame (1) a small stimulating feed trough (8) is placed to provide syrup to the bees when the beekeeper deems it necessary. The trough (8) has a lid (11) with a sieve (12) to protect the food from exogenous agents.

### THE FIELD OF ART

The invention relates to the field of feeder technique for beehives and in particular refers to feeders with separate locations for the solid and the liquid food for bees. It further relates to a feeder having a separate smaller trough for stimulating feeding of bees.

### BACKGROUND OF THE INVENTION

The feeder disclosed in this invention has a small stimulating feed trough and has not been disclosed in the prior art.

One of the major problems faced by beekeepers is how to feed their bees and supply them with liquids. In nature, a bee swarm makes sure that its hive is close to both food and nectar, which is the main source of honey. Thus, one of the things beekeepers care about is to ensure that beehives have easy access to liquid and solid food to avoid getting hassle and be focused on harvesting nectar for the production of honey.

Until now, beekeepers usually place a bowl of syrup and sugar-paste that they use as solid feed for the bees, directly on the honeycomb-frames, inside the hive. This ensures that the bees have direct access to it excluding access to any other bugs or parasites. There are multiple disadvantages resulting from this method. First, placing food directly on the honeycombs makes it difficult to move the bees, while at the same time the upper part of the honeycombs is often destroyed. In addition, moisture growth favours the creation of pathogenic organisms, which can damage the beehive but also spoil its production. Further problems arise during cleaning and disinfection of the utensils used, since food residues can become sources of infection for the beehive.

Another problem existing to date is the multiple bee deaths occurring inside the utensil with the liquid placed for the bees. The problem arises from the fact that many of the bees, either by mistake or by overcrowding, can fall into the utensil, wetting their bodies and their wings, causing them to drown, but also to infect the liquid.

In addition till now, when a beekeeper wishes to stimulate the beehive to increase it, he is forced to provide a separate supply of food in a controlled manner, which requires his continued presence. Further, it is not feasible to stimulate the bee feeding with a single feeder.

It is an object of the present invention to advantageously overcome the aforementioned drawbacks and deficiencies of the prior art by proposing a feeder with a small stimulating substance trough that allows the supply of solid and liquid food to the bees while allowing the bees' stimulating feeding.

It is further object of the present invention to propose a feeder with a small stimulating feed trough carrying the solid food positioned in the middle allowing easy access of the bees to it from inside during the winter months.

It is further object of the present invention to provide a feeder with a small stimulating feed trough, which is elevated for providing greater safety and capacity for both solid and liquid food.

It is a further object of the invention to provide a feeder with a curved lid for maintaining the temperature above the solid and liquid food so that it does not freeze during the winter months.

Still another advantage of the invention is the presentation of a feeder with a small stimulating feed trough, which has a perimeter rim protecting against rain and air.

Another object of the invention is to provide a feeder with a small stimulating feed trough, which has an inlet-outlet safety small door, which facilitates the bees during the winter months to leave the hive for motion, so that the beehive is not at risk from the development of illnesses, such as nosemosis.

It is a further object of the present invention to provide a feeder with a small stimulating feed trough which has a lid to prevent bees from directly accessing the substance at the risk of drowning. In addition, the lid has reticulated slots in order to allow the beekeeper to add the liquid substance, without necessarily opening the lid.

These and other objects, features and advantages of the invention will become apparent in the detailed following description.

### BRIEF DESCRIPTION OF THE DRAWINGS

The invention will become apparent to those skilled in the art with reference to the accompanying drawings, in which it is illustrated in an exemplary, non-limiting manner.

FIG. 1 shows the feeder with the liquid food trough and the solid food place.

FIG. 2 is a perspective section view of the feeder of FIG. 1.

FIG. 3 shows the small stimulating feed trough to be placed in the feeder of the present invention.

FIG. 4 shows the reticulated lid for the small stimulating feed trough of FIG. 3.

FIG. 5 illustrates the small stimulating feed trough in combination with the closure lid which protects the substance from external harmful agents. The stimulating feed trough can be placed both inside and outside the feeder.

FIG. 6 is an illustrative plan view of the perforated grill which prevents the bees from directly accessing the solid foodstuff located in the feeder.

FIG. 7 is a plan view of the curved lid to be placed over the solid foodstuff to protect it from pathogenic microorganisms, bugs or other harmful agents.

FIG. 8 is a schematic drawing of the detachable cover positioned on both the feeder and the stimulating feed trough.

### DETAILED DESCRIPTION OF THE PREFERRED EMBODIMENT

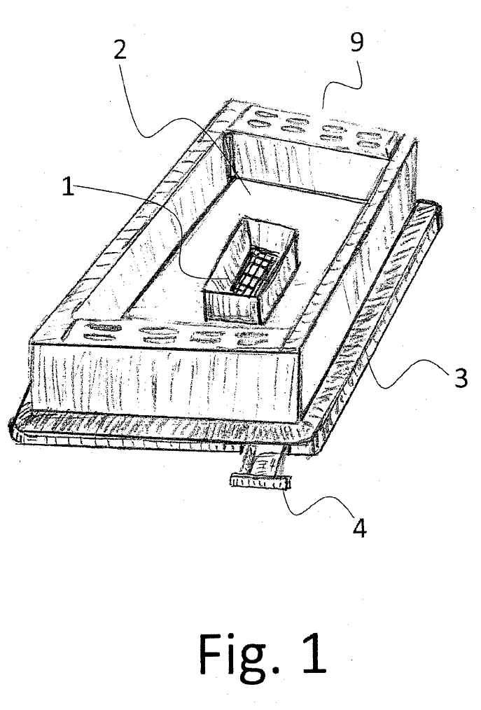

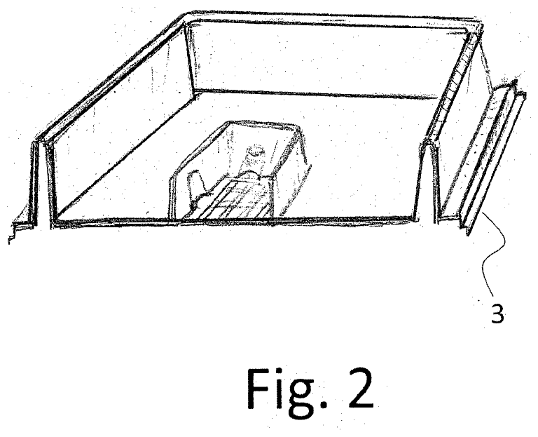

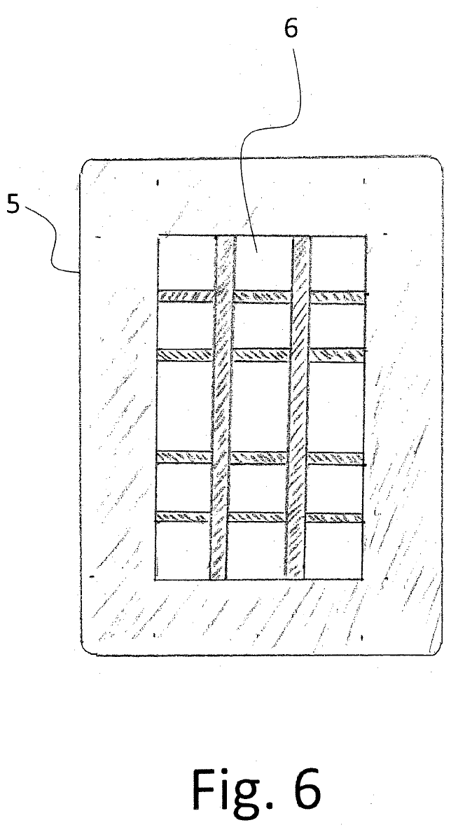

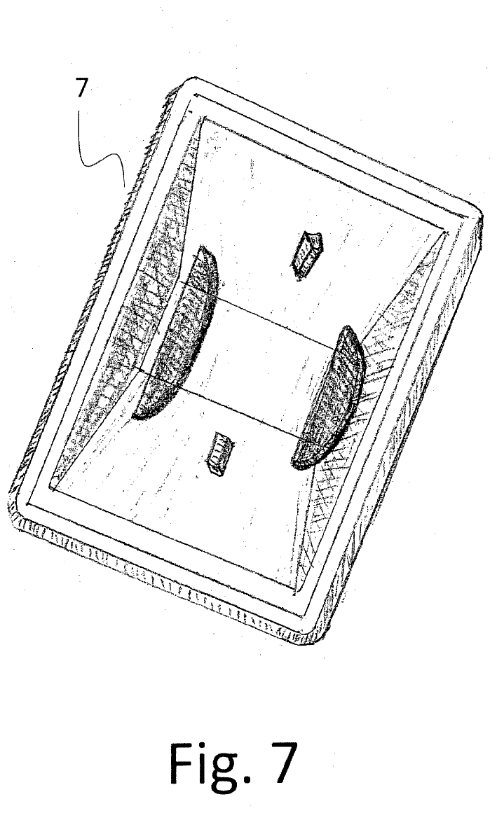

Referring now to the accompanying drawings, we will illustrate exemplary embodiments of the feeder with the small stimulating feed trough. The feeder comprises a frame (1), FIG. 1, for the placement of the solid food, circumferentially surrounded by a tray (2) for placing the liquid food. The feeder has a perimeter flange (3) to rest on hives, internally or externally, essentially complementing the hive. As shown in the section of accompanying FIG. 2, both the flange (3) and the walls of the tray (2) have the appropriate room to allow the bees to move between the walls and be able to reach their feed. The feeder has an opening with a door (4) which is sliding and which allows and assists the bees' flight when approaching or leaving the feeder. Further, the beekeeper can close it when he does not want the bees to go out, as for example during transportation. On the underside of the frame (1) there is a detachable grill (5), FIG. 6, with perforated sieve (6), which allows the bees to access the solid food from the feeder's underside, without risking to be entombed by the food. In order to further protect the solid food, the frame (1) is covered with a lid (7), FIG. 7, which is curved and protects the solid foodstuff from the weather conditions, especially in winter, so as not to freeze, maintaining the appropriate temperature.

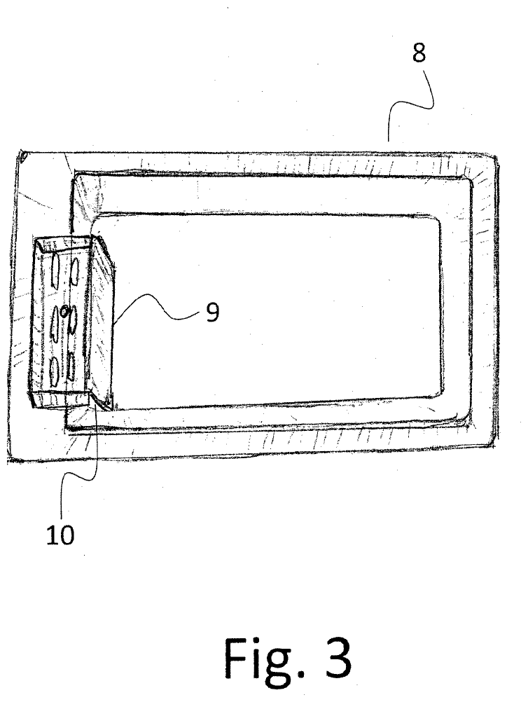

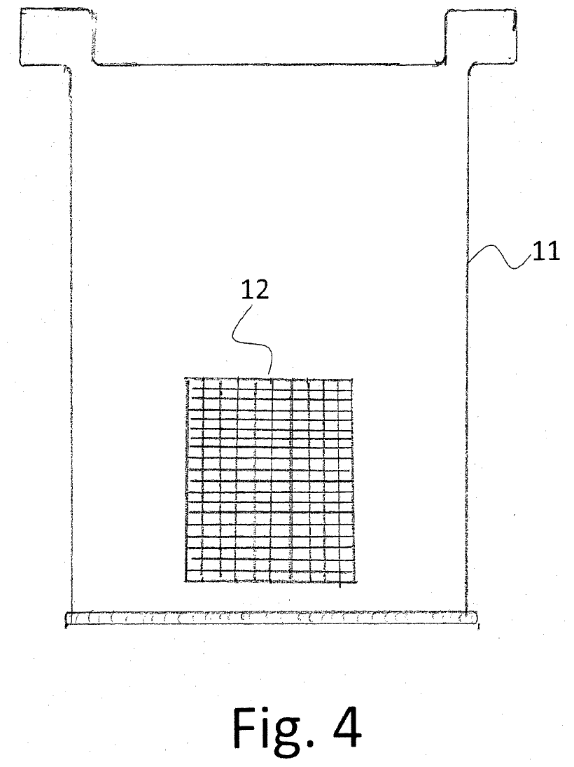

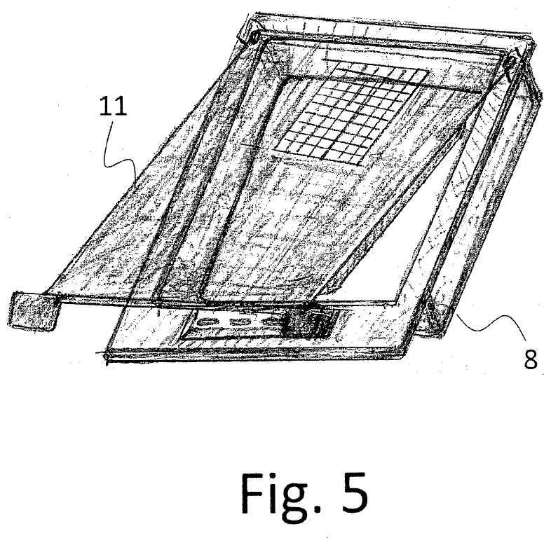

In addition, the feeder has a small trough (8), FIG. 3, which is placed within the frame (1), to enable the beekeeper to stimulate the bees' feeding. The trough (8) is fitted with a lid (11), FIG. 4, opening upwards, which in a part thereof has a sieve (12) for the addition of liquid food by the beekeeper without having to open it. The lid (11), when closed, FIG. 5, prevents access of any bug or other undesirable insect to the syrup.

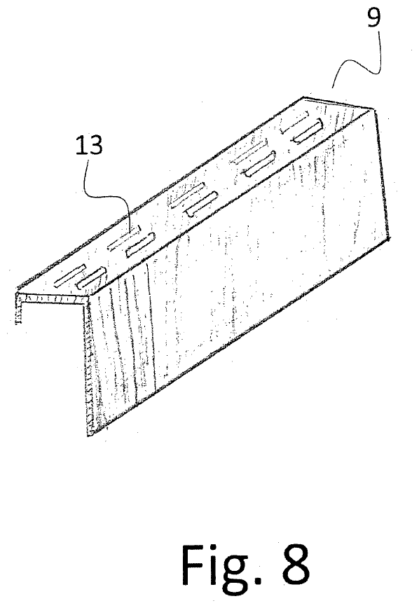

One of the special features of the feeder is the way the liquid food is delivered to the bees. The liquid food tray (2), FIG. 1, at its two ends has detachable covers (9), FIG. 8, from which the bees may internally take the syrup through the openings (10). The tray (2) is obviously slightly inclined towards the edges for the liquid to flow towards the openings (10) formed between the covers (9) and the perimeter walls of the tray (2). The covers (9) help to protect the bees, since they do not allow uncontrolled access to the basin room (1), with the risk of drowning in the available amount of the syrup. Further, the detachable covers (9) have at their top one or more openings (13) to allow air to channel into and out of the hive to maintain the necessary and appropriate temperature. Similarly, the stimulating feed trough (8) has a removable cover (9), FIG. 3, whereas on the underside of the detachable cover (9) there are holes, not shown in FIG. 3, so that the bees enter one by one into the cover (9) and receive the liquid present in the small trough (8) from the opening (10) formed on either side of the cover (9). In this way, even in periods of limited flowering, the bees receive the liquid food, believing that flowering is present, resulting in feeding the queen and the beehive, leading to gestation and increase of the beehive population.

It is to be noted here that the description of the invention has been made by reference to exemplary embodiments, not being limited thereto. Therefore, any alteration or modification in terms of shape, dimensions, manufacturing and assembly materials and components, if they are not a novel inventive step and do not contribute to the technical development of the already known one, are considered to be within the scope of the present invention as summarized in claims that follow.

1. A feeder with a small stimulating feed trough made up of a tray (2) and a frame (1), characterized in that a small trough (8) is placed within the frame (1) with a lid (12) bearing a sieve (12), within which liquid food for bees is placed, the bees moving from underside to take it from openings (10) formed between the detachable cover (9) and the walls from the trough (8).
